(19) United States
(12) Patent Application Publication
(10) Pub. No.: US 2020/0031647 A1
(43) Pub. Date: Jan. 30, 2020

(54) One kind of red wine bottle opener

(71) Applicants: Moshe Landau, Monroe, NY (US); Chen Lei Peng, Yongkang (CN); Mao Jian Ping, Ningbo (CN)

(72) Inventors: Moshe Landau, Monroe, NY (US); Chen Lei Peng, Yongkang (CN); Mao Jian Ping, Ningbo (CN)

(21) Appl. No.: 16/553,194

(22) Filed: Aug. 28, 2019

(30) Foreign Application Priority Data
Jul. 26, 2018 (CN) 201821194446.2

(51) Int. Cl. B67B 7/08; B67B 7/04

(52) U.S. Cl. CPC B67B 7/08; B67B 2007/0458; B67B 7/04

(57) ABSTRACT

The present invention relates to a corkscrew, comprising a positioning cylinder, and the needle inflator; positioned symmetrically on both sides of the cartridge a notch opening, the upper end of the notch portion extends to the end to end of the positioning cylinder, the lower end extends close to the lower end to end positioning cylinder the position of the portion, at both sides of the positioning cylinder notches symmetrically arranged circular arc shape in cross section the elastic pressing disc, the lower end of the elastic pressing piece are connected to the lower end of the positioning tube and integrally formed on its upper end extends to near the end to end positioning cylinder portion of the position, horizontal and inwardly at both ends thereof, respectively, the upper end of the cutting blade is mounted; the central cylinder is provided with an upper end of the positioning pin holes; puncture needle hollow interior, with its upper air inlet, the lower end of the tip-side portion thereof is provided vent, the needle passes through the pinhole down, with inflation head puncture needle inflator inlet port in communication.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention relates to a daily necessities, in particular to a wine bottle opener.

### Description of the Related Art

Wine bottle packaging foil needs to cut the seal at the time of opening, after pulling up the cork through the bottle opener.

There are tools on the market dedicated to bottle the seal of the foil wrapping paper cut, during operation, the tool prone to skew results in foil ring cut off not likely to occur once or circumcision adhesion conditions, the latter need to continue to cut its circumcision time-consuming, poor quality circumcision.

There is also a plug opening and a cut ring integral opener, such as Application No. “201,420,004,482.3” Utility Model Patent, but for circumcision tool at the lower end of the entire apparatus, and which, when the seal of the foil will be cut because only the lower end of the ring the entire apparatus is provided with the bottle at the sleeve, is easy with respect to the overall bottle skewed, there is circumcision or blocking phenomenon cannot effectively cut off, and the circumcision operation cannot be completed integrally needle cylinder, there is a long sequence of operations successively on the entire operation interval.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The present invention is to solve the technical problem of providing a wine bottle opener, effectively overcome the drawbacks of the prior art.

The present invention to solve the aforementioned technical problems the technical solution as follows: A wine bottle opener, comprising a positioning cylinder, and the needle inflator;

Open lower end positioned above the cylinder barrel, open on both sides thereof symmetrically notched, the lower notch end to end on the upper end portion of the notch extends to the positioning tube extends to a position close to the lower end to end of the positioning cylindrical portion, the above-described positioning cylinder notch symmetrically arranged on both sides in cross section arcuate elastic pressing disc, the lower end of the elastic pressing pieces are connected to the lower end of the positioning tube and integrally formed, at its upper end portion extends to a position close to said end to end positioning cylinder position, and respectively at the same level as at the level of the cutter blade attached to the upper end.

The central upper end of the positioning cylinder is provided for the puncture needle through the pinhole; hollow interior of the puncture needle, which is provided with an upper air inlet, the lower end of the tip-side portion thereof is provided with a hole, by the tip of the puncture needle down through the pinhole above, the pneumatic inflation head means with said needle intake port in communication.

The beneficial effects of the present invention are: simple structure, easy to operate, can be effective for packaging wine bottle mouth ring is cut, and can quickly, easily open the mouth of the bottle cork.

Based on the above technical solution, the present invention may also be modified as follows.

Further, the puncture needle outside the fixing sleeve end to end with the hub portion, the upper end of the needle hub is provided with a blind hole and an intake air inlet of the puncture needle in communication, the above-described inflatable device inflation head extends into the intake gas blind hole, communicates through the intake port and the intake hole and the blind puncture needle.

Further the above embodiment is advantageous effect of this design facilitates communication with the puncture needle inflatable device.

Further, further comprising positioning the inner telescopic tube and the outer tube, the inner tube is positioned vertically disposed upper and lower ends are open Cylinder, the lower end of the positioning cylinder is connected to the fixed end to end with the upper portion of the positioning cylinder, and said pin holes of the inner cylinder coaxially disposed the positioning, on the inner side wall of the positioning tube from top to bottom of the spirally It provided that at least one guide groove through the side wall of the outer telescopic tube is disposed vertically and the upper and lower ends of the cylinder are open, and the positioning sleeve disposed outside the cylinder above the needle seat disposed above the positioning cylinder which is attached to the side end of the horizontal slide guide and the guide grooves one to one, one end of the guide remote from the slider of the needle holder passes through the guide groove corresponding to, and connected and fixed to the outer telescopic tube described above; and the vertical inflator straight provided, which projects into the lower end of the inner sleeve is positioned within the upper end of the positioning cylinder, end to end lower portion of the inflator provided with the inflator head, the upper end of the inflator projecting to the upper end of the upwardly extending outer telescopic cylinder open, the force driving the telescopic rotation of the outer cylinder, the outer cylinder can be driven by the above-described telescoping tube.

A further embodiment of the above-described advantageous effect that the design is more subtle, the entire apparatus compact structure and easy operation of adjusting the position of the vertical movement of the puncture needle, puncture needle conducive cork.

Further, the above-described inflator bottle of R-134a, which has a lower end to end portions push the inflation head in communication with the interior thereof.

A further embodiment of the above-described advantageous effect of the inflator is simple operation, just to inject gas into the pressing needle.

Further, the lower end of the guide groove is continuously provided at a horizontal locating groove, the external force drives the outer telescopic tube is rotated, the telescopic outer cylinder above the guide slider can be driven to slide along the positioning groove of the guide groove, so that the telescoping outer tube and said needle fixed.

A further embodiment of the above-described advantageous effect of the positioning groove is designed to facilitate the telescopic movement of the outer tubular needle driven to the fixed positioning of the bottom, facilitates the subsequent operations to open the bottle.

Further, the upper end of the outer telescopic tube is provided with a pressure lever.

A further embodiment of the above-described advantageous effect is to facilitate the entire apparatus by applying pressure to the handle, such that the puncture needle punctured through the cork.

Further, an upper inner horizontal two ends of each of the elastic pressing piece is provided for fixing the cutter blade stage blade, said cutting blades respectively fixed to the horizontal portion corresponding to the end to end stage blade, and which is positioned closer to the a portion of the inner tube extends to the center of the cutter table.

A further embodiment of the above-described advantageous effect that the design facilitates cutting blade fixed.

Further, the above-described cutting insert wafer specifications are the same, the above-described four cutting blades located on the circumference of the same circle a circle.

A further embodiment of the above-described advantageous effect is designed, so that four cutting blades can be simultaneously and uniformly to the wrapping paper at a uniform seal bottle circumcision, circumcision good quality.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 of the present invention a wine bottle opener sectional view of the structure;

FIG. 2 is a schematic vertical cross-sectional structure of a wine bottle opener invention.

In the drawings, a list of members of each numeral represent the following:

1, positioning cylinder 2, positioning the inner cylinder 3, the telescopic outer tube 4, the puncture needle 5, the inflator 11, the elastic pressing pieces 12, cutting blade 21, the guide groove 22, the guide slide, 31, the push lever 41, needle hub 51, inflation head 111, knife sets.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Conjunction with the drawings of the present invention the principles and features described, The examples are only intended to illustrate the invention and are not intended to limit the scope of the invention.

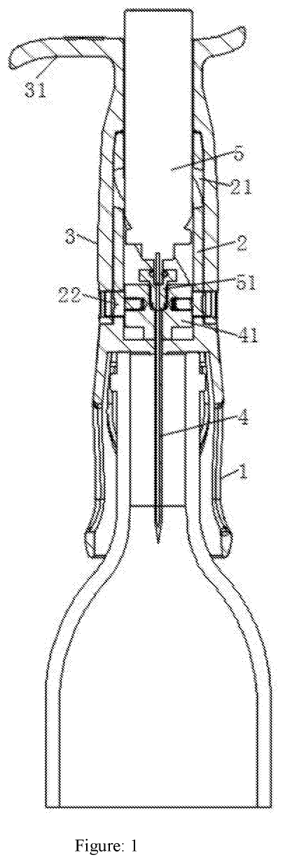

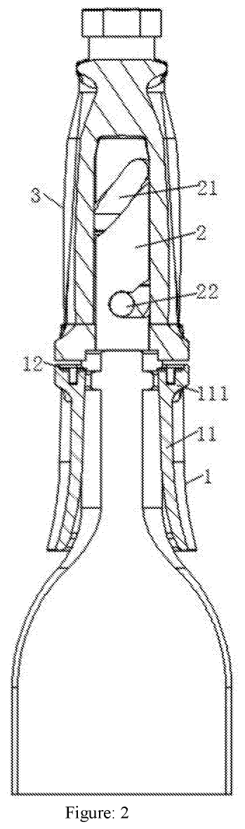

Example: 1, the puncture needle 4 and the inflator 5 as shown in FIGS. 1 and 2, the corkscrew of the present embodiment includes a positioning cylinder;

The positioning cylinder 1 is open at the lower end of the cylindrical body, open on both sides thereof symmetrically notch, the notch extends to the upper end of the tube end to end of the positioning portion 1, a lower end of the notch extends close to the positioning cylinder at one end to end section position, the gap at both sides of the positioning cylinder 1 is provided with a symmetrical cross section with rounded elastic pressing pieces 11, the lower end of the elastic pressing pieces 11 are connected to the lower end of the positioning cylinder 1 integrally formed and which extends to the upper end to end portion positioned near the positioning cylinder 1, respectively, and at the same level as at the level of the cutter blade 12 is attached at its [0032] The central upper end of the positioning cylinder is provided with a supply of the puncture needle 4 passes through the pinhole; hollow interior of the puncture needle 4, with its upper air inlet, the lower end portion side thereof is provided with a vent needle, the puncture needle 4 by the upper tip down through the pinhole above the head 5 to inflate the inflatable device 51 communicates with the intake port puncture needle 4.

During use, the positioning cylinder in a wine bottle is sleeved mouth, so that the top end of the bottle mouth portion of the sleeve 1 against the positioning (the bottleneck of the bottle and designed to match the size of the opening of the positioning cylinder 1, a positioning cylinder when encircling the bottleneck does not occur significantly skew shaking), set in the process, the outer elastic pressing pieces 11 to expand by pressing the bottleneck, when the cartridge 1 is positioned in an outer sleeve disposed bottleneck, the cutting blade 12 the force of the elastic deformation of the tabs 11 pressed tightly against the sealing wrapper bottleneck at the bottle after rotation of one pair of positioning cylinder seal packaging bottles at bottle high-quality cut ring; with the puncture needle 4 can be 1 in the process of pressing down the movable sleeve bottleneck provided through synchronization of the positioning cylinder cork bottle at a bottle, or packaging after completion of the sealing ring is pressed down movable cutting cork puncture; and upon completion of the sealing ring cut after penetrating the needle 4 so that the cork tip leakage decentralized cork vent, the inflator 5 is injected through the gas amount wine bottle, the wine bottle with the increase of pressure, pressure extruded cork upwardly, i.e., the bottle can be completed unplugging, the entire operation Very convenient, by sealing the wrapping paper of the cutting process, only an external force to twist the positioning cylinder 1, rapid, convenient, and high-quality cutting ring, ring adhesion did not completely cut off condition does not occur.

The positioning cylinder 1 may be cylindrical, or may be small cones is larger.

Preferably, the outer sleeve of the puncture needle end to end fixing portion 4 is provided with a needle hub 41, the upper end of the needle hub 41 is provided with an intake hole and the blind puncture needle 4 of the intake port communicating with the inflator 5 the inflation head 51 projects into the intake blind hole, and communicates through the intake hole and the blind puncture needle intake port 4, the design of the needle hub 41 to facilitate mounting the puncture needle 4, the needle hub 41 acts as the entire inflator 4 pneumatic communication between the head 51 and the puncture needle 5 “Mediator”, Such that the puncture needle 4 can effectively complete flow communication with the inflator 5.

In some embodiments, further comprising an outer telescopic tube 2 and the inner cylinder 3 is positioned, the cartridge 2 is arranged vertically and open at both upper and lower ends positioned within said cylinder, the lower end of the inner cylinder 2 and the positioning of the positioning of the cartridge 1 connected end to end on a fixed portion, and said positioning pin holes and the inner tube 2 coaxially disposed, helically top to bottom side wall of the inner cylinder 2 is provided with positioning at least one side wall through which the guide groove 21, above the telescopic outer tube 3 is arranged vertically and open upper and lower ends of each cylinder, and the outer sleeve 2 provided in the inner cylinder is positioned, the needle holder 41 provided in the inner tube 2 is positioned, which is attached to the side end of the horizontal 21 correspond to the guide groove of the slider guide 22, the guide slider 22 away from the needle hub 41 through a corresponding end of the guide groove 21, and 3 connected to the outer telescopic tube fixing; and the vertical inflator 5 provided, which projects into the lower end of the inner tube 2 is positioned inside the upper end of the inner tube 2 is positioned, end to end lower portion of the inflator 5 is provided above the inflation head 51, the upper end. The outer cylinder 3 can drive the guide groove 21 slides up and down along the guide 22 corresponding to the slider, so that the above-mentioned telescopic cylinder 3 and the puncture needle 4 is telescopically movable up and down, the entire design to achieve plug opening which has two actions:

(1) Before the bottle, rotation of the telescopic outer cylinder 3, it is positioned relative to the inner cylinder 2 is moved down at a stroke to the maximum (i.e., the lower end of the outer tube and is telescopically positioned end to end portion of the tube 3 against 1), in the process, slider guide 22 along the guide groove 21 is moved downward to the lower end to end after the portion of the guide groove 21, and drive the puncture needle 4 and the inflator 5 downward synchronization, this state, the puncture needle is also synchronized to move downward at the maximum stroke, the positioning cylinder in the bottle 1 is sleeved outside of the bottleneck, the synchronization process is completed sleeved puncture needle 4 through the vertical middle of the operation of the bottle cork bottle, the bottle until the bottle 1 end to end with the positioning cylinder against the upper end, the next step, the entire device is rotated or positioning cylinder 1 to complete the sealing ring 12 pairs of cutting the wrapper bottle finish cutting blade, after the gas is injected into the bottle by the inflator 5, during injection, gradually increasing the pressure bottle, in the above the outside atmospheric pressure is rapidly upwardly extruded cork, i.e. red wine bottle through the process of cutting and sealing packaging unplugging the ring.

(2) Before the bottle, rotation of the telescopic outer cylinder 3, it is positioned relative to the inner cylinder 2 is moved down at a stroke to the maximum (i.e., the lower end of the outer tube and is telescopically positioned end to end portion of the tube 3 against 1), in the process, slider guide 22 is moved upward along the guide groove 21 to the upper portion of the guide groove 21 of the end to end, the puncture needle 4 and drive means 5 and the inflator synchronization shift upward puncture needle tip 4 is moved close to the top wall of the positioning cylinder or retracted into 1 pinhole positioned end to end cylindrical portion 1, the next step, the cartridge positioning a sleeved bottle bottleneck, after sleeved well, under force of the elastic deformation of the tabs 11, all the cutting blades 12 are abutting outer wrapping of the seal bottleneck, after a complete rotation of the positioning cylinder sealing ring cut of the wrapper, then the next step, the telescopic force pressing down and rotating the outer cylinder 3, the outer cylinder 3 to drive the telescopic guide the slider 22 is moved downward along the guide groove 21 to the lower portion of the guide groove 21 of the end to end, and puncture needle 4 driven through the cork, after the gas is injected into the bottle by the inflator 5, during injection, the inner pressure is gradually increased, in after above ambient atmospheric pressure, is rapidly cork upwardly extruded, I.e., complete the wine bottle and seal packaging.

The guide groove 21 is provided with two, and distributed in the side wall of the inner cylinder positioned on opposite sides of the guide and the slider 22 are connected by through-screws screwed in the telescopic outer cylinder 3 on the outer tube 3 is fixed to the knock.

Preferably, the above-described inflator bottle 5 is R-134a, which has a lower end to end portions push the inflation head 51 communicating the inside thereof, by a pneumatic head 51 extends into the bottle needle hub R-134a inlet upper end of the blind bore 41 the external force pressing down the bottle when the R-134a, the valve 51 is opened in the inflation head, the R-134a vaporized upon inflation head 51 is formed by an intake pressure R-134a blind hole 4 through the needle into the bottle, the entire operation is very simple, Convenience.

Preferably, the lower end of the guide groove 21 is provided continuously at a horizontal locating groove, the external force driving the rotation of the telescopic outer cylinder 3, the above-described telescopic outer cylinder 3 can drive the slider 22 of the guide 21 slides along the guide groove to the above-described positioning slot, so that the outer telescopic tube of the puncture needle 3 and 4 fixed, the design is such that the outer telescopic tube 2 is positioned within the cylinder 3 is moved downward with respect to the maximum stroke (i.e., the lower end is telescopically positioned in the outer cylinder 3 when the cartridge 1 is brought into end to end portions), under the action of the positioning grooves such that the horizontal section of the vertical displacement of the guide slider 22 hardly occurs, so that the vertical displacement of the puncture needle 4 doe.

Preferably, the upper end of the outer cylinder 3 is provided with a telescopic push lever 31, to facilitate the application of an external telescopic beat movable and rotates the outer cylinder 3 by pressing lever 31 downwards.

Preferably, two of the upper end inside the elastic pressing piece 11 are respectively provided to both ends of the horizontal fixing the cutter blade 12 of cutter units 111, the above-described cutting blades 12 are fixed to the horizontal corresponding to the blade end to end stage 111 portion, and a part of which is closer to the cylinder 1 is positioned inside the blade extends to the center of stage 111, stage 111 and the elastic blade pressing plate 11 is integrally formed, both connected to the high structural strength, not broken, while the design of the tool table 111 facilitates the cutting blade

Best the cutting insert 12 are the same size discs, the above-described four cutting blades 12 located on the center of a circumference of the same circle, the cutting blade 12 are tapered blade four weeks, its force uniformly and easy breakage pressure.

The positioning cylinder 1, inner cylinder 2 is positioned, the telescopic outer tube 3 and the resilient tabs 11 are formed by PVC.

The above preferred embodiment of the present invention are illustrative only, not intended to limit the present disclosure, any modification within the spirit and principle of the invention, the, equivalent replacement, or improvement, it should be included in the present utility within the scope of protection.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1) A corkscrew, which is characterized in that: a positioning cylinder (1), the puncture needle (4) and the inflator (5); said positioning cylinder open at the lower end of the cylinder, both sides symmetric opened notch that extends to the upper end of the positioning cylinder (1) on the end to end portion, a lower end of the cutout portion extends to a position close to the lower end to end positioning cylinder (1), the positioning cylinder (1) it is provided with notches at both sides of the symmetrical arc-shaped cross section of the elastic pressing piece (11), the lower end of the elastic pressing sheet (11), respectively, the lower end of the positioning cylinder (1) is connected to and integrally formed, which extends to a position close to the upper end (1) end to end of the positioning cylinder portion, respectively, and at the level of the same level is attached to the cutter blade (12) The central positioning cylinder (1) is provided with pinholes for the upper end of the puncture needle (4) therethrough; said puncture needle inside a hollow, with its upper air inlet, the lower end side of the needle tip section is provided with a hole, the tip of the puncture needle (4) by said down through the pinhole, the inflator (5) of the inflation head (51) of the needle (4) of the intake communication port.

2) A corkscrew according to one of the preceding claims, characterized in that: the end to end portion of the puncture needle (4) Fixing sleeve provided with an external hub (41), the upper end of the hub (41) is provided with a blind hole of the intake needle (4) communicating the intake port, the inflator inflator (5) head (51) extending into said blind bore inlet and communicates through the intake hole and the blind puncture needle (4) of the intake port.
a) One kind according to claim 2 of the corkscrew, which is characterized in that: further comprising positioning the inner cylinder (2) and an outer telescoping Cylinder (3), positioning the inner tube (2) is disposed vertically and the upper and lower ends of the cylinder are open, said lower end positioned within the cartridge (2) with the positioning cylinder (1) connected end to end on the fixed and the inner cylinder of the positioning pin holes (2) arranged coaxially, the top to bottom positioning spirally on the side wall of the inner cylinder (2) is provided with at least one side wall through which a guide grooves (21), the telescopic outer tube (3) is arranged vertically and open at both the upper and lower ends of the cylindrical body and the positioning sleeve disposed in the inner tube (2) outside the hub (41) disposed locating said inner tube (2), which side is attached to the end of the horizontal guide groove (21) one to one guide slide (22), the guide slide (22) away from said needle hub (41) through the end of the corresponding guide grooves (21), and (3) is connected to the telescopic outer tube is fixed; the inflator (5) arranged vertically, the lower end of the inner cylinder is positioned (2) positioning the inner tube extending into the upper end (2) inside, said inflator (5) is provided with a lower portion of said inflation head end to end (51), an upper end of said inflator (5) extends up to the extended telescoping an outer cylinder (3) open at the upper end, the driving force of the outer telescopic tube (3) Moving the outer telescopic tube (3) can drive the slide guide (22) sliding along the corresponding guide grooves (21) up and down, so that the outer telescopic tube (3) and the puncture needle (4) vertically telescopic movement.

3) According to claim 3, said one kind of corkscrew, which is characterized in that: said inflator (5) is R-134a bottles that End to end with the lower portion of the inflatable push head (51) communicating the inside thereof.
a) According to a corkscrew according to claim 3, wherein: the lower end of the guide groove (21) of the continuous is provided at a horizontal locating groove, the driving force of the outer telescopic tube (3) is rotated, the telescopic outer tube (3) can drive the slide guide (22) along said guide groove (21) slides to the positioning slot, so that the outer telescopic tube (3) and the puncture needle (4) fixed.
b) A corkscrew according to claim one kind of any one of claims 3-5, characterized in that: the telescopic outer tube (3) Pressure lever is provided with an upper end (31).
c) According to a corkscrew according to any one of claims 1 to 3, characterized in that: the two elastic pressing piece a horizontal upper ends are provided inside the cutter deck (110 for securing said cutting blade (12), said cutting blades (12) are fixed horizontally to a corresponding blade of said table (111) portion of the end to end, and a portion proximate to the positioning cylinder (1) extending to the center of the inside of the knife station (111).
d) According to claim 3, said one kind of corkscrew, which is characterized in that: said cutting blades (12) are a specification Consistent wafer, the four cutting blades (12) located on the circumference of the same circle a circle.
